(19) United States
(12) Patent Application Publication
(10) Pub. No.: US 2025/0074092 A1
(43) Pub. Date: Mar. 6, 2025

(54) INK EJECTION MECHANISM, PRINTING DEVICE, AND METHOD FOR FIXING INKJET HEAD

(71) Applicant: MIMAKI ENGINEERING CO., LTD., Nagano (JP)

(72) Inventor: Tetsuharu IKEDA, Nagano (JP)

(73) Assignee: MIMAKI ENGINEERING CO., LTD., Nagano (JP)

(21) Appl. No.: 18/726,411

(22) PCT Filed: Dec. 20, 2022
(86) PCT No.: PCT/JP2022/046761

§ 371 Date: Jul. 3, 2024

(30) Foreign Application Priority Data
Jan. 5, 2022 (JP) 2022-000628

(51) Int. Cl. B41J 25/34; B41J 2/175

(52) U.S. Cl. CPC B41J 25/34; B41J 2/175

(57) ABSTRACT

An ink ejection mechanism, a printing device, and a method for fixing an inkjet head are provided for easy attachment of the inkjet head to a carriage. An ink ejection mechanism includes: a carriage that moves along a print surface of a recording medium; a head assembly that is detachably disposed on the carriage and ejects ink onto the recording medium; and a fixing unit that fixes the head assembly to the carriage by pressing the head assembly from above.

### TECHNICAL FIELD

The present invention relates to an ink ejection mechanism, a printing device, and a method for fixing an inkjet head.

### BACKGROUND ART

Printing devices in which an inkjet head ejects ink to form an image on a medium while a carriage on which the inkjet head is mounted moves relative to the medium have been widely used.

In such printing devices, the inkjet head is replaced due to malfunction, maintenance, or the like. In this case, it is necessary to adjust a position of the inkjet head on the carriage when a new inkjet head is mounted on the carriage.

Patent Literature 1 describes an ejection-direction position regulation mechanism that regulates movement of recording heads in an ejection direction of ink from a nozzle in order to adjust positions where the recording heads (inkjet heads) are fixed to an attachment base (carriage).

In a printing device in Patent Literature 1, a plurality of recording heads that eject the same color are provided, and the plurality of recording heads are mounted on a module base, and then are mounted on a carriage for each module base. Fixing and fine adjustment between the recording head and the module base are performed by a fixing component including a screw.

### CITATION LIST

### Patent Literature

Patent Literature 1: Japanese Unexamined Patent Publication No. 2006-188013

### SUMMARY OF INVENTION

### Technical Problems

However, in the position adjustment described in Patent Literature 1, when a size of the recording head increases or the number of recording heads increases, workability may deteriorate. In addition, a worker needs to use a tool suitable for the screw in order to finely adjust a mounting position of the recording head by the screw, and the worker needs to have a skilled technique for the fine adjustment performed by using the tool.

Hence, objects of the present invention are to provide an ink ejection mechanism, a printing device, and a method for fixing an inkjet head for easy attachment of the inkjet head to a carriage.

### Solutions to Problems

An ink ejection mechanism according to one aspect of the present invention includes: a carriage that moves along a print surface of a medium; an inkjet head that is detachably disposed on the carriage and ejects ink onto the medium; and a fixing unit that fixes the inkjet head to the carriage by pressing the inkjet head from above.

According to this configuration, since the fixing unit is used to fix the inkjet head to the carriage, there is no need to perform work for fastening the inkjet head and the carriage with a screw as in the related art. Since the fixing unit fixes the inkjet head to the carriage by pressing the inkjet head from above, the inkjet head can be easily attached to the carriage.

In the ink ejection mechanism described above, the fixing unit may include a first fixing component that fixes the fixing unit to the carriage, and a second fixing component that fixes the inkjet head to the carriage. According to this configuration, the inkjet head can be easily attached to the carriage by the first fixing component and the second fixing component.

In the ink ejection mechanism described above, the first fixing component may be a male screw which is inserted into a hole formed in the fixing unit, and the male screw may be screwed into a female screw formed in the carriage. According to this configuration, a worker can easily attach the fixing unit to the carriage by screwing the male screw which is the first fixing component into the female screw formed in the carriage.

In the ink ejection mechanism described above, the second fixing component may include an operation member provided outside a side surface portion of the fixing unit, and a head fixing member that is provided inside the fixing unit and holds down the inkjet head from above depending on an operation on the operation member to fix the inkjet head to the carriage. According to this configuration, the worker can easily attach the inkjet head to the carriage via the fixing unit by operating the operation member.

In the ink ejection mechanism described above, the head fixing member may include a lever member that is pivoted depending on the operation on the operation member, and a pressing member that is attached to a lower end of the lever member via a biasing member and presses the inkjet head against the carriage. According to this configuration, the worker can easily attach the inkjet head to the carriage via the fixing unit by pivoting the operation member.

In the ink ejection mechanism described above, the carriage may include a position adjuster that adjusts a position of the inkjet head in a horizontal direction on an upper surface of the carriage. According to this configuration, the position of the inkjet head can be easily adjusted in the horizontal direction.

In the ink ejection mechanism described above, the position adjuster may include a cylindrical rotary member that rotates around a central shaft and has a contact surface which comes into contact with a side surface of the inkjet head directly or via another member, the contact surface having a thickness which changes in a rotation direction. According to this configuration, the worker can easily adjust the position of the inkjet head in the horizontal direction by rotating the position adjuster.

In the ink ejection mechanism described above, a pressure adjuster that adjusts pressure of the ink and supplies the ink to the inkjet head may be disposed on top of the inkjet head, and an ink supply connector may be coupled to a plurality of ink inflow units of the pressure adjuster to be simultaneously detachable together. According to the present configuration, the ink supply connector can be easily attached to the pressure adjuster.

A printing device according to one aspect of the present invention includes the ink ejection mechanism described above.

According to one aspect of the present invention, there is provided a method for fixing an inkjet head that is detachably disposed on a carriage which moves along a print surface of a medium and that ejects ink onto the medium, the method including: a first step of disposing the inkjet head on the carriage; a second step of disposing, on the carriage from above the inkjet, a fixing unit that fixes the inkjet head to the carriage; a third step of fixing the fixing unit to the carriage by a first fixing component provided in the fixing unit; a fourth step of adjusting a horizontal position of the inkjet head on an upper surface of the carriage by a position adjuster provided on the upper surface of the carriage; and a fifth step of fixing the inkjet head to the carriage by a second fixing component provided in the fixing unit.

### Effect of the Invention

Objects of the present invention are to provide an ink ejection mechanism, a printing device, and a method for fixing an inkjet head for easy attachment of the inkjet head to a carriage.

### BRIEF DESCRIPTION OF THE DRAWINGS

FIG. 1 is a perspective view of an inkjet printer of this embodiment.

FIG. 2 is a schematic diagram of an ink ejection mechanism of this embodiment.

FIG. 3 is a schematic view of a head assembly of this embodiment.

FIG. 4 is a schematic view illustrating steps of attaching the head assembly of this embodiment to a carriage.

FIG. 5 is a schematic view illustrating a state in which the head assembly is attached to the carriage by a fixing unit of this embodiment.

FIG. 6 illustrates schematic views of a first fixing component and a second fixing component of the fixing unit of this embodiment, in which (a) of FIG. 6 is a schematic side view of the first fixing component, and (b) of FIG. 6 is a schematic side view of the second fixing component.

FIG. 7 is a schematic top view of the second fixing component of the fixing unit of this embodiment.

FIG. 8 illustrates enlarged schematic views of states before and after an operation performed on an operation member of this embodiment, in which (a) of FIG. 8 is an enlarged schematic view of a state before the operation member is lowered, and (b) of FIG. 8 is an enlarged schematic view of a state in which the operation member has been lowered.

FIG. 9 is an external perspective view of a position adjuster of this embodiment, in which (a) of FIG. 9 is an overall view including an inkjet head, and (b) of FIG. 9 is an enlarged view of the position adjuster.

FIG. 10 is a configurational view of an ink supply connector of this embodiment, in which (a) of FIG. 10 is an external view, and (b) of FIG. 10 is an exploded view of an upper part and a lower part.

FIG. 11 illustrates longitudinal sectional views illustrating steps of coupling the ink supply connector and an ink inflow unit of this embodiment, in which (a) of FIG. 11 is a view illustrating a state before the coupling, (b) of FIG. 11 is a view illustrating a state during the coupling, and (c) of FIG. 11 is a view illustrating coupling completion.

FIG. 12 is a flowchart illustrating steps of attaching the head assembly of this embodiment to the carriage.

FIG. 13 is a schematic view of a fixing unit of the other embodiment.

### DESCRIPTION OF EMBODIMENTS

Hereinafter, an inkjet printer 1 according to an embodiment of the present invention will be described with reference to the drawings.

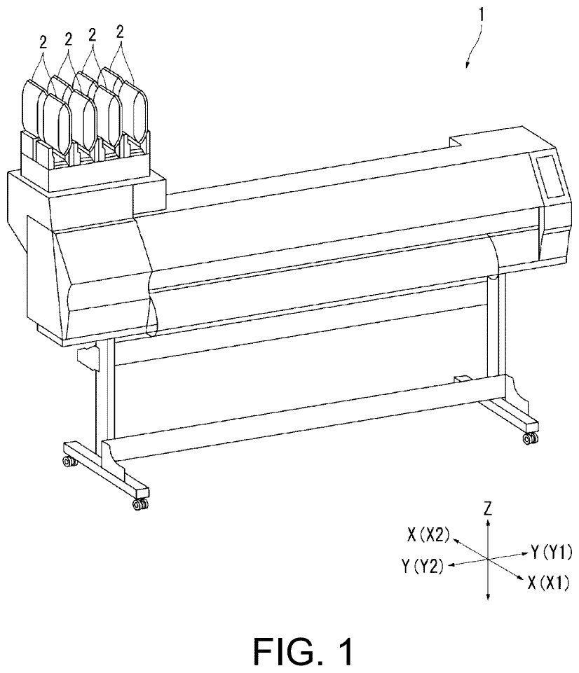

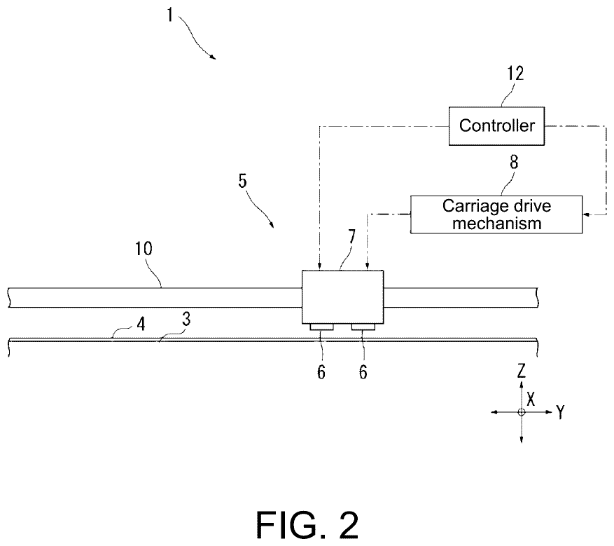

FIG. 1 is a perspective view of the inkjet printer 1 of this embodiment. FIG. 2 is a schematic view of an ink ejection mechanism 5 of the inkjet printer 1 illustrated in FIG. 1. In the following description, a main scanning direction (Y direction) is referred to as a “leftward-rightward direction”, and a sub scanning direction (X direction in FIG. 1 and the like) orthogonal to a vertical direction (Z direction in FIG. 1 and the like) and the main scanning direction is referred to as a “frontward-rearward direction”. In addition, a Y1 direction side in FIG. 1 and the like which is one side in the leftward-rightward direction is referred to as a “right” side, and a Y2 direction side in FIG. 1 and the like which is an opposite side to the right side is referred to as a “left” side. An X1 direction side in FIG. 1 and the like which is one side in the frontward-rearward direction is referred to as a “front” side, and an X2 direction side in FIG. 1 and the like which is an opposite side to the front side is referred to as a “rear” side.

The inkjet printer 1 of this embodiment is, for example, a professional-quality inkjet printer, and performs printing on a recording medium 4 placed on a platen 3 by using ink contained in an ink storage unit 2. Examples of the recording medium 4 include printing paper, a fabric, a resin film, or the like.

An ink ejection mechanism 5 of the inkjet printer 1 includes an inkjet head 6, a carriage 7, a carriage drive mechanism 8, and a guide rail 10. In addition, the inkjet printer 1 further includes a controller 12 for controlling the ink ejection mechanism 5.

The inkjet head 6 is detachably disposed on the carriage 7, and ejects ink supplied from the ink storage unit 2 onto the recording medium 4 based on image data. As an example, the inkjet head 6 ejects an ultraviolet-curable ink (UV ink) downward. A lower surface of the inkjet head 6 has a nozzle surface (ink ejection surface) in which a plurality of nozzles are arranged and a piezoelectric element (piezo element) that ejects ink from a nozzle.

The carriage 7 moves in a direction (main scanning direction that is the Y direction) orthogonal to a transport direction (sub scanning direction that is the X direction in FIG. 1 and the like) of the recording medium 4. More specifically, the inkjet head 6 is mounted on the carriage 7, and the carriage 7 is moved in the main scanning direction by the carriage drive mechanism 8 while being guided in the main scanning direction by the guide rail 10.

The carriage drive mechanism 8 includes, for example, two pulleys, a belt stretched between the two pulleys and partially fixed to the carriage 7, and a motor that rotates the pulleys.

The controller 12 controls the motor of the carriage drive mechanism 8 based on image data, and outputs an ink ejection signal based on the image data to the inkjet head 6 to cause the inkjet head 6 to eject ink.

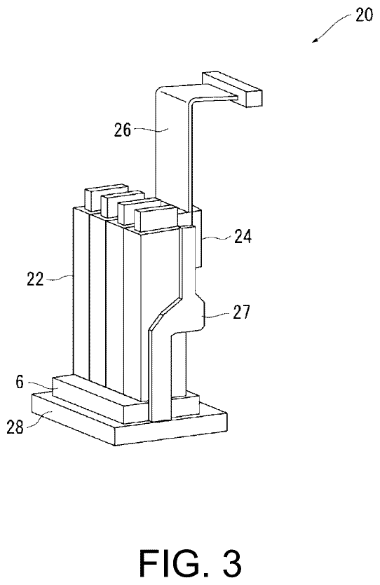

FIG. 3 is a schematic view of an assembly (hereinafter referred to as a “head assembly”) 20 including the inkjet head 6 of this embodiment.

The head assembly 20 includes a pressure damper 22, a relay board 24, a relay cable 26, a flexible flat cable (hereinafter referred to as an “FFC”) 27, and an adjustment plate 28, in addition to the inkjet head 6.

The pressure damper 22 is a pressure adjuster which is disposed on top of the inkjet head 6, to which ink is supplied from the ink storage unit 2, and which adjusts pressure of the ink and then supplies the ink to the inkjet head 6. The pressure damper 22 has a plurality of ink supply ports according to a type of color ejected by the inkjet head 6 and the number of nozzle rows, and supplies ink to the inkjet head 6.

A control signal such as a head drive signal is input to the relay board 24 from the controller 12 via the relay cable 26. This control signal is output to the inkjet head 6 via the pressure damper 22 and the FFC 27.

The adjustment plate 28 is a fixing plate for attaching the inkjet head 6 to the carriage 7 regardless of a shape or a type of the inkjet head 6. The inkjet head 6 is connected to the adjustment plate 28 by using a screw.

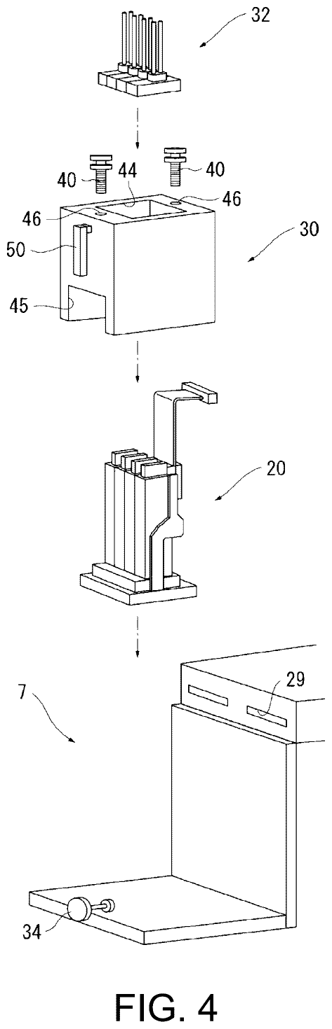

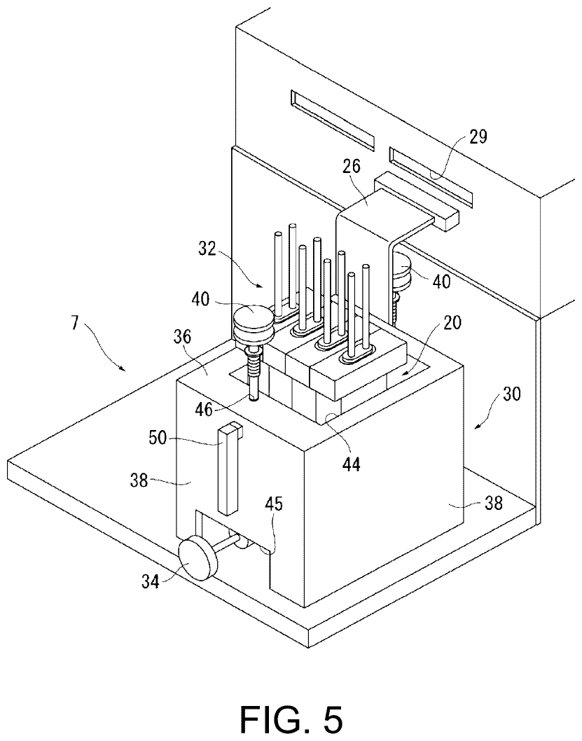

FIG. 4 is a schematic view illustrating steps of attaching the head assembly 20 of this embodiment to the carriage 7. FIG. 5 is a schematic view illustrating a state in which the head assembly 20 is attached to the carriage 7 by a fixing unit 30 of this embodiment. FIG. 5 illustrates a case where one head assembly 20 is fixed to the carriage 7 by the fixing unit 30; however, the present invention is not limited thereto, and two or more head assemblies 20 may each be fixed to the carriage 7 by the fixing unit 30. In addition, the fixing unit 30 to be described below is also an example, and two or more fixing units 30 may be integrally formed as long as the fixing units 30 have the same basic configuration.

The head assembly 20 is attached to the carriage 7 by the fixing unit 30. The fixing unit 30 fixes the inkjet head 6 to the carriage 7 by pressing the head assembly 20 including the inkjet head 6 from above.

When the head assembly 20 is fixed to the carriage 7 by the fixing unit 30, an ink supply connector 32 for supplying ink to an upper portion of the pressure damper 22 is connected. The relay cable 26 is connected to a port 29 of the carriage 7.

In addition, the carriage 7 includes a position adjuster 34 on an upper surface thereof. The position adjuster 34 is a member that adjusts a position of the inkjet head 6 in the horizontal direction on an upper surface of the carriage 7, and is operated by a worker. The fixing unit 30 has an opening 45 so that the fixing unit 30 and the position adjuster 34 do not interfere with each other when the fixing unit 30 is fixed to the carriage 7.

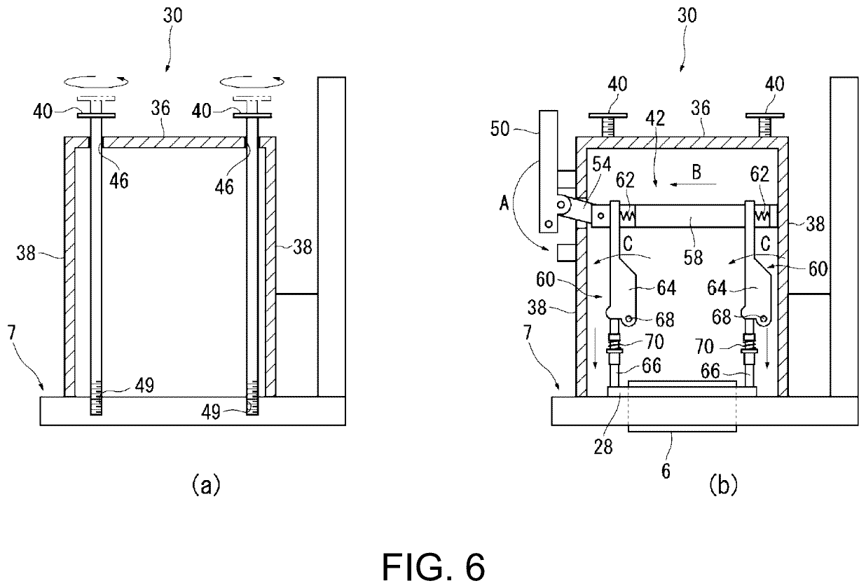

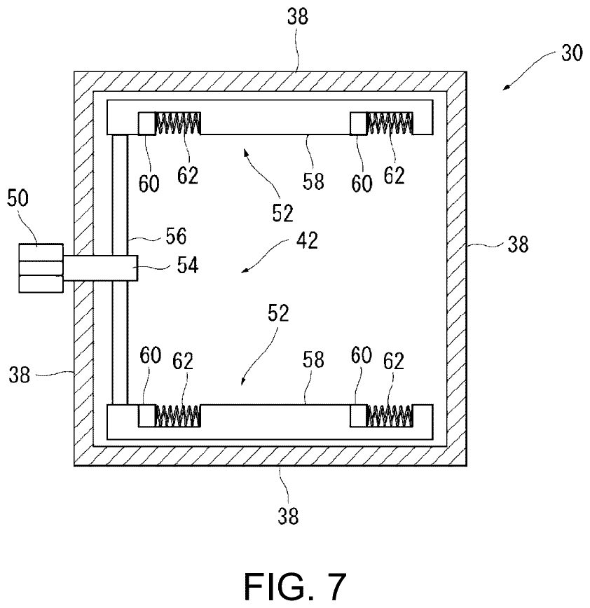

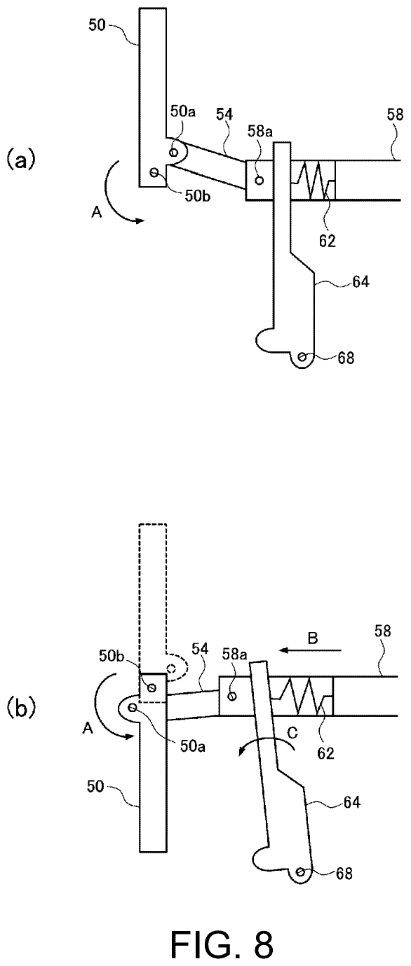

Next, a configuration of the fixing unit 30 and the fixing of the inkjet head 6 (head assembly 20) to the carriage 7 by the fixing unit 30 will be described with reference to FIGS. 6 to 8. FIG. 6 is a schematic view illustrating configurations of a first fixing component 40 and a second fixing component 42 of the fixing unit 30 of this embodiment. (a) of FIG. 6 is a schematic side view of the first fixing component 40, and (b) of FIG. 6 is a schematic side view of the second fixing component 42. FIG. 7 is a top view of the second fixing component 42 of this embodiment. FIG. 8 is an enlarged schematic view illustrating states before and after an operation performed on an operation member 50 of this embodiment. (a) of FIG. 8 is an enlarged schematic view of a state before the operation member 50 is lowered, and (b) of FIG. 8 is an enlarged schematic view of a state in which the operation member 50 has been lowered. In FIGS. 6 to 8, the configuration of the head assembly 20 is partially omitted as appropriate.

The fixing unit 30 includes an upper surface portion 36, side surface portions 38, the first fixing component 40, and the second fixing component 42 that fixes the inkjet head 6 to the carriage 7.

The upper surface portion 36 has an opening 44 through which an upper portion of the head assembly 20 projects, and two insertion holes 46 into which the first fixing component 40 (male screw) is inserted. As an example, the side surface portions 38 include four surfaces to surround the head assembly 20.

The first fixing component 40 is a member that fixes the fixing unit 30 to the carriage 7. The first fixing component 40 of this embodiment is a male screw having a length from an upper surface of the fixing unit 30 to the carriage 7. The male screw is inserted into the insertion hole 46 formed in the upper surface portion 36 of the fixing unit 30, and is screwed into a female screw 49 formed in the carriage 7. An upper portion of the male screw is, for example, a knob, and a worker can easily attach the fixing unit 30 to the carriage 7 by pinching and rotating the knob.

In this embodiment, as an example, the insertion holes 46 are formed at two positions on the upper surface portion 36 of the fixing unit 30, and the female screws 49 are formed in the upper surface of the carriage 7 to be aligned with these positions. However, the number of the insertion holes 46 and the number of the female screws 49 are not limited thereto, and may be one or more.

In addition, the fixing unit 30 of this embodiment has the first fixing components 40 in the vicinity of the front surface side on which the operation member 50 to be described below is provided and in the vicinity of a back surface side on the opposite side to the front surface side, but the present invention is not limited thereto. The first fixing components 40 may be provided, for example, in the vicinity of the left and right side surface portions 38 of the fixing unit 30. In addition, the insertion holes 46 may be holes penetrating the side surface portions 38 from the top to the bottom, and the first fixing components 40 may be inserted into the side surface portions 38, respectively. As described above, the positions where the insertion holes 46 are formed are not limited as long as the fixing unit 30 can be fixed to the carriage 7 by the first fixing components 40.

The second fixing component 42 is a member that fixes the inkjet head 6 to the carriage 7. The second fixing component 42 of this embodiment includes an operation member 50 and head fixing members 52.

The operation member 50 is a lever that is provided outside the side surface portions 38 of the fixing unit 30 and pivots in the vertical direction. The operation member 50 of this embodiment is connected to, via the fastening member 54, a central portion of a coupling member 56 sandwiched between two sets of head fixing members 52. Both ends of the coupling member 56 are connected to a link member 58 constituting the head fixing member 52.

The head fixing members 52 are provided inside the fixing unit 30, and hold down the head assembly 20 from above depending on an operation on the operation member 50 to fix the inkjet head 6 to the carriage 7. The head fixing member 52 of this embodiment has two sets of head fixing members 52 provided along inner surfaces of the left and right side surface portions 38 of the fixing unit 30. One end of each of the two sets of head fixing members 52 in a longitudinal direction is coupled to another end thereof by the coupling member 56 extending in a direction orthogonal to a surface along which the head fixing members 52 extend.

The head fixing members 52 on both sides connected via the fastening member 54 and the coupling member 56 can be simultaneously moved, by pivoting the operation member 50 upward or downward.

The head fixing member 52 includes a pair of link members 58 and two hold-down members 60 on each side, along inner surfaces of the left and right side surface portions 38.

One link member 58 is coupled to the other link member 58 by a coupling member 56. Each link member 58 extends in the horizontal direction in one of the left and right side surface portions 38 of the fixing unit 30, and springs 62 which are biasing members are provided at two positions in an extending direction of the link member. One end (coupling member 56 side) of each spring 62 is connected to an upper side surface of the hold-down member 60, and the other end of each spring 62 is connected to the link member 58.

The hold-down member 60 includes a lever member 64 and a pressing member 66.

The lever member 64 pivots depending on an operation on the operation member 50. The pressing member 66 is attached to a lower end of the lever member 64 via a spring 70, and presses the inkjet head 6 against the carriage 7. More specifically, the lever member 64 extends downward from the link member 58, the spring 62 is connected to the upper side surface, and the pressing member 66 is provided at the lower end. The lever member 64 is a lever that has a pivotable shaft 68 pivotally supported inside the side surface portions 38 of the fixing unit 30 and pivots about the pivotable shaft 68.

In addition, as illustrated in the enlarged schematic views of FIG. 8, one end of the fastening member 54 is coupled to a fastening hole 50a of the operation member 50, and the other end of the fastening member 54 is coupled to a fastening hole 58a of the link member 58 via the coupling member 56. The fastening hole 50a of the operation member 50 is formed in a projecting portion on one end side from a central portion of operation member 50. In addition, a rotation shaft 50b of the operation member 50 is formed at one end of the operation member 50.

According to a configuration of the second fixing component 42 as described above, when a worker pivots the operation member 50 about the rotation shaft 50b of the operation member 50, in an A direction in FIGS. 6 and 8, the fastening member 54 pulls the link member 58 in a B direction. As a result, the lever member 64 connected to the link member 58 via the spring 62 is pivoted about the pivotable shaft 68 in a C direction. The pressing member 66 presses the inkjet head 6 (adjustment plate 28) against the carriage 7 according to the movement of the lever member 64 that is pivoted depending on the operation performed on the operation member 50. The head assembly 20 is fixed to the carriage 7 by an operation of the second fixing component 42 described above.

In this embodiment, the head fixing members 52 are provided on two facing surfaces of the fixing unit 30, and each head fixing member 52 includes the two hold-down members 60. Therefore, the fixing unit 30 holds down the four corners of the adjustment plate 28 by the four hold-down members 60.

As described above, the fixing unit 30 of this embodiment can easily fix the head assembly 20 (inkjet head 6) to the carriage 7 by the operation member 50 that is operated by the worker. In a case where the inkjet head 6 is unfixed from the carriage 7, the operation member 50 is pivoted upward from a lower side.

In addition, the head fixing member 52 includes the lever member 64 that is pivoted depending on the operation on the operation member 50, and the pressing member 66 that is attached to the lower end of the lever member 64 via the spring 70 and presses the head assembly 20 against the carriage 7. As described above, the head fixing member 52 can fix the inkjet head 6 to the carriage 7 with a strong hold-down force by a mechanism obtained by combining a spring and a leverage.

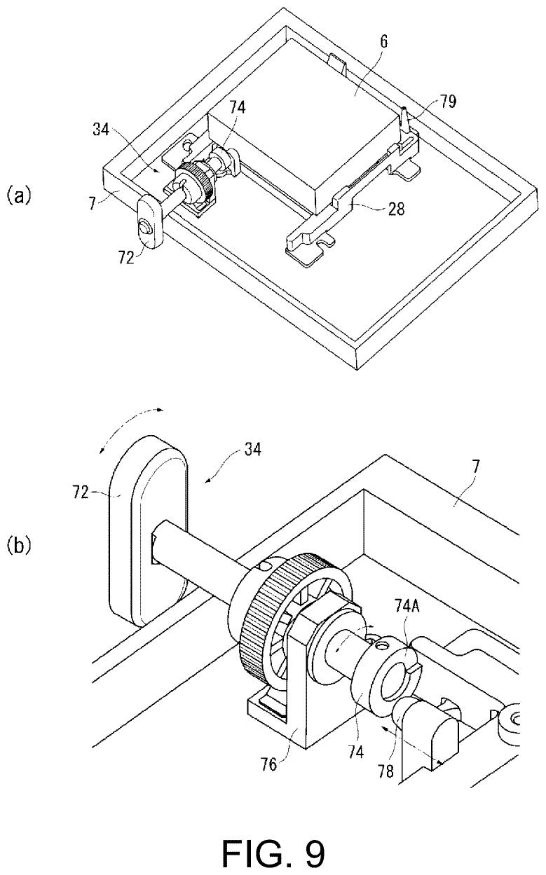

FIG. 9 is an external perspective view of the position adjuster 34 of this embodiment. (a) of FIG. 9 is an overall view including the inkjet head 6, and (b) of FIG. 9 is an enlarged view of the position adjuster 34.

The position adjuster 34 of this embodiment includes a rotation operating member 72 operated by a worker and a cylindrical rotary member 74. A central shaft of the rotary member 74 is coaxial with a central shaft of the rotation operating member 72, and the rotary member 74 is also rotated by rotating the rotation operating member 72. The rotation operating member 72 and the rotary member 74 are rotatably fixed to the carriage 7 by a support member 76.

The rotary member 74 rotates around the central shaft and has a contact surface 74A that comes into contact with the head assembly 20 (the adjustment plate 28 in this embodiment) and has a thickness which changes in a rotation direction. Specifically, the contact surface 74A of the rotary member 74 is formed in a spiral shape in which the thickness changes. The adjustment plate 28 has a contact portion 78 that comes into contact with the contact surface 74A of the rotary member 74.

In addition, a rotation center portion 79 is provided at a position of the carriage 7 which is symmetrical about a point target with respect to the contact portion 78, with the inkjet head 6 interposed therebetween.

According to such a configuration, when the worker rotates the rotation operating member 72 in a direction in which the thickness of the rotary member 74 increases, the rotary member 74 pushes the contact portion 78 of the adjustment plate 28. As a result, the head assembly 20 is pivoted around the rotation center portion 79 in the horizontal direction, and the worker can easily adjust the position of the head assembly 20.

In addition, the adjustment plate 28 may be brought into contact with the carriage 7 via a biasing member such as a spring that pushes back the adjustment plate toward the rotary member 74. As a result, even if the head assembly 20 is pushed by the position adjuster 34, the head assembly 20 moves back toward original position thereof by a biasing force of the biasing member by reversely rotating the rotation operating member 72, and fine adjustment of the head assembly 20 can be performed.

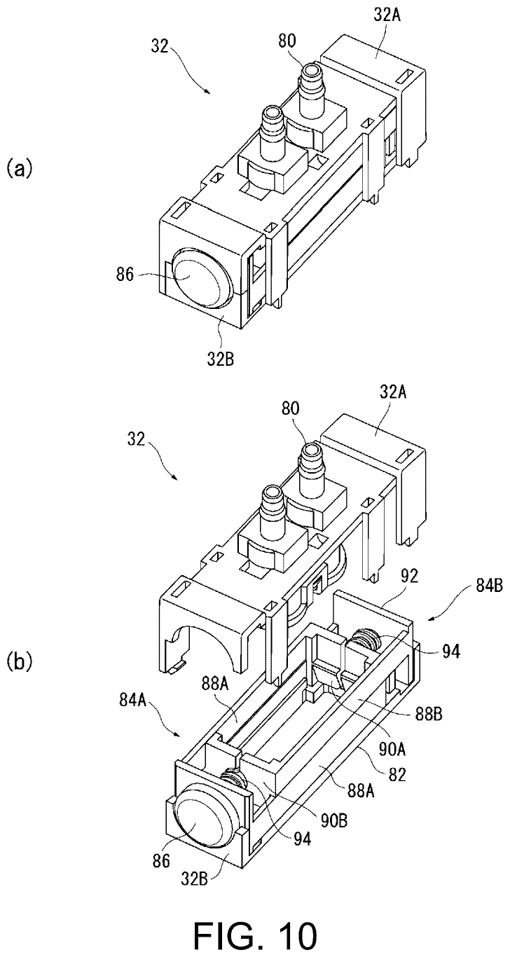

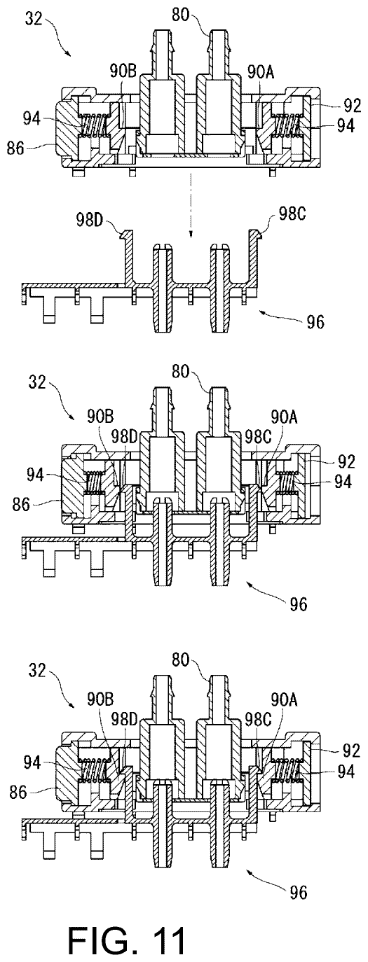

Next, a configuration of the ink supply connector 32 connected to the pressure damper 22 will be described with reference to FIGS. 10 and 11. FIG. 10 is a configurational view of the ink supply connector 32 of this embodiment, in which (a) of FIG. 10 is an external view, and (b) of FIG. 10 is an exploded view of an upper part 32A and a lower part 32B. FIG. 11 illustrates longitudinal sectional views illustrating steps of coupling the ink supply connector 32 and an ink inflow unit 96 provided in the pressure damper 22 of this embodiment, in which (a) of FIG. 11 is a view illustrating a state before the coupling, (b) of FIG. 11 is a view illustrating a state during the coupling, and (c) of FIG. 11 is a view illustrating coupling completion.

The ink supply connector 32 is a component that supplies ink to the pressure damper 22, and is detachably attached to the plurality of ink inflow units 96 of the pressure damper 22 simultaneously.

As illustrated in FIG. 10, the ink supply connector 32 of this embodiment has the upper part 32A and the lower part 32B. That is, the ink supply connector 32 is formed by fitting the upper part 32A and the lower part 32B into each other.

The upper part 32A has an ink supply flow path 80. The ink supply flow path 80 is connected to the ink inflow units 96 of the pressure damper 22, and supplies ink to the pressure damper 22. Two flow paths are formed in the ink supply flow path 80 illustrated in FIGS. 10 and 11, and the ink is supplied for each flow path to the pressure damper 22; however, the present invention is not limited thereto, and as the ink supply connector 32, one having the ink supply flow paths 80 corresponding to the number of ink inflow units 96 of the pressure damper 22 is appropriately selected. In addition, a check valve for preventing backflow of ink is provided on the ink supply flow path 80.

The lower part 32B has an opening formed in a lower surface member 82 so that the ink supply flow path 80 and the ink inflow unit 96 of the pressure damper 22 can be connected. In addition, connecting members 84A and 84B are arranged on the lower surface member 82 to overlap each other in the vertical direction.

The connecting member 84A has a push button 86, and a claw portion 90A is provided on the opposite side to the push button 86 via a side plate 88A. In addition, the connecting member 84B has a bilaterally symmetrical structure with the connecting member 84A, and a claw portion 90B is provided on the opposite side to a backing plate 92 via a side plate 88B. Each of the claw portions 90A and 90B has an inclined surface inclined downward and a horizontal surface formed at a position of an upper end of the inclined surface.

A spring 94 is disposed in each of a gap between a back surface of the push button 86 of the connecting member 84A and a back surface of the claw portion 90B of the connecting member 84B and a gap between a back surface of the backing plate 92 of the connecting member 84B and a back surface of the claw portion 90A of the connecting member 84A.

As illustrated in FIG. 11, claw portions 98C and 98D are formed in the ink inflow unit 96. Each of the claw portions 98C and 98D has an inclined surface inclined upwardly downward and a horizontal surface formed at a position of a lower end of the inclined surface. That is, the claw portions 98C and 98D have shapes symmetrical to the shapes of the claw portions 90A and 90B to be fitted into the claw portions 90A and 90B of the ink supply connector 32.

Next, coupling between the ink supply connector 32 and the ink inflow unit 96 of the pressure damper 22 will be described with reference to FIG. 11.

First, the worker pushes the ink supply connector 32 from above the ink inflow unit 96 ((a) of FIG. 11). As a result, the claw portion 98C pushes the claw portion 90A toward the backing plate 92, and the claw portion 98C pushes the claw portion 90B toward the push button 86. As described above, the claw portions 90A and 90B are pushed and expanded by the claw portions 98C and 98D ((b) of FIG. 11).

When the ink supply connector 32 is pushed into the ink inflow unit 96 until the horizontal surfaces of the claw portions 90A and 90B and the horizontal surfaces of the claw portions 98C and 98D abut each other, the claw portions 90A and 90B return to original positions thereof and are closed ((c) of FIG. 11). As a result, the ink supply connector 32 is coupled (locked) to the ink inflow unit 96. Hence, the worker can easily attach the ink supply connector 32 to the pressure damper 22.

On the other hand, in a case where the ink supply connector 32 and the ink inflow unit 96 are uncoupled from each other, the worker pulls the ink supply connector 32 upward while pressing the push button 86. The push button 86A is pressed, and thereby the claw portions 90A and 90B are opened. Hence, the claw portions 90A and 90B and the claw portions 98C and 98D are unfitted from each other, and the worker can easily remove the ink supply connector 32 from the ink inflow unit 96.

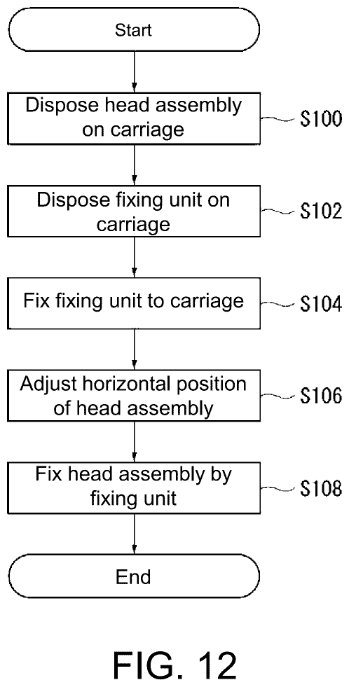

FIG. 12 is a flowchart illustrating steps of attaching the head assembly 20 of this embodiment to the carriage 7.

First, in step S100, the head assembly 20 is disposed at a predetermined position of the carriage 7.

In the next step S102, the fixing unit 30 is mounted on the carriage 7 from above the head assembly 20.

In the next step $104, the fixing unit 30 is fixed to the carriage 7 by the first fixing component 40 provided in the fixing unit 30.

In the next step S106, the horizontal position of the head assembly 20 is adjusted on the upper surface of the carriage 7 by the position adjuster 34 provided on the upper surface of the carriage 7.

In the next step S108, the head assembly 20 is fixed to the carriage 7 by the second fixing component 42 provided in the fixing unit 30.

The present invention has been described with reference to the above-described embodiments; however, the technical scope of the present invention is not limited to the scope described in the above embodiments. Various modifications or improvements can be added to the above-described embodiments within a range without departing from the gist of the invention, and a configuration obtained by adding the modifications or improvements is also included in the technical scope of the present invention. In addition, the above-described embodiments may be appropriately combined. For example, the present invention can also be applied to a flatbed type inkjet printer.

In the above-described embodiments, the configuration in which the inkjet head 6 is fixed to the carriage 7 via the adjustment plate 28 has been described; however the present invention is not limited thereto, and a configuration in which the inkjet head 6 is fixed to the carriage 7 without using the adjustment plate 28 may be employed. In a case of this embodiment, the second fixing component 42 of the fixing unit 30 holds down the upper end portion of the inkjet head 6 against the carriage 7.

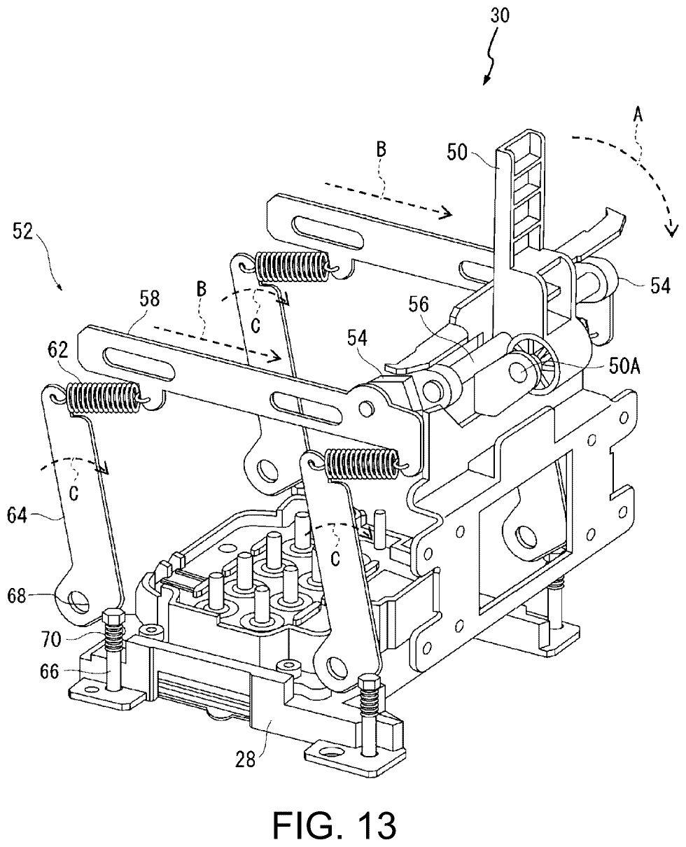

In addition, the configuration of the fixing unit 30 is not limited to the configuration of the above-described embodiment. FIG. 13 illustrates a configuration of a fixing unit 30 according to the other embodiment. The operation member 50 illustrated in FIG. 13 is fixed to the central portion of coupling member 56 that couples two sets of head fixing members 52, and a rotation shaft 50A is provided obliquely below a position of a front surface from the fixing position to the coupling member 56. Both end portions of the coupling member 56 are connected to the link member 58 constituting the head fixing member 52 via the fastening member 54. As described above, one end of the fastening member 54 is rotatably coupled to the coupling member 56, and the other end is rotatably coupled to the link member 58. The link member 58 is positioned obliquely downward with respect to the coupling member 56.

In the configuration illustrated in FIG. 13, when the worker pivots the operation member 50 downward from an upper side (A direction), the coupling member 56 and the fastening member 54 move in a direction of the operation member 50 (B direction). Accordingly, the link member 58 also moves in the B direction. When the link member 58 moves in the B direction, the pressing member 66 presses the adjustment plate 28 against the carriage 7 as the lever member 64 connected to the link member 58 by the spring 62 is pivoted downward (C direction) around the pivotable shaft 68. On the other hand, the operation member 50 is pivoted upward from a lower side, the head fixing member 52 moves in the opposite direction to the above, and the fixing is released.

### Effects of Embodiment

(1) An ink ejection mechanism 5 of this embodiment includes: a carriage 7 that moves in a direction orthogonal to a transport direction of a recording medium 4; a head assembly 20 that is detachably disposed on the carriage 7 and ejects ink onto the recording medium 4; and a fixing unit 30 that fixes the head assembly 20 to the carriage 7 by pressing the head assembly 20 from above.

According to this embodiment, since the fixing unit 30 is used to fix the head assembly 20 to the carriage 7, there is no need to perform work for fastening the head assembly 20 and the carriage 7 with a screw as in the related art. Since the fixing unit 30 fixes the head assembly 20 to the carriage 7 by pressing the head assembly 20 from above, the head assembly 20 can be easily attached to the carriage 7.

(2) The fixing unit 30 of this embodiment includes the first fixing component 40 that fixes the fixing unit 30 to the carriage 7 and a second fixing component 42 that fixes the head assembly 20 to the carriage 7. According to this embodiment, the head assembly 20 can be easily attached to the carriage 7 by the first fixing component 40 and the second fixing component 42.

(3) The first fixing component 40 of this embodiment is a male screw inserted into the insertion hole 46 formed in the fixing unit 30, and the male screw is screwed into a female screw 49 formed in the carriage 7. According to this embodiment, the worker can easily attach the fixing unit 30 to the carriage 7 by screwing the male screw 49 which is the first fixing component 40 into the female screw formed in the carriage 7.

(4) The second fixing component 42 of this embodiment includes the operation member 50 provided outside side surface portions 38 of the fixing unit 30, and the head fixing members 52 are provided inside the fixing unit 30, and hold down the head assembly 20 from above depending on an operation on the operation member 50 to fix the head assembly 20 to the carriage 7. According to this embodiment, the worker can easily attach the head assembly 20 to the carriage 7 via the fixing unit 30 by operating the operation member 50.

(5) The head fixing member 52 of this embodiment includes the lever member 64 that is pivoted depending on the operation on the operation member 50, and the pressing member 66 that is attached to the lower end of the lever member 64 via the spring 70 and presses the head assembly 20 against the carriage 7. According to this embodiment, the worker can easily attach the head assembly 20 to the carriage 7 via the fixing unit 30 by pivoting the lever.

(6) The carriage 7 of this embodiment includes the position adjuster 34 that adjusts the position of the head assembly 20 in the horizontal direction on the upper surface of the carriage 7. According to this configuration, the position of the head assembly 20 can be easily adjusted in the horizontal direction.

(7) The position adjuster 34 of this embodiment includes the cylindrical rotary member 74 that rotates around the central shaft, and has the contact surface 74A which comes into contact with the side surface of the head assembly 20 and has the thickness that changes in the rotation direction. According to this embodiment, the worker can easily adjust the position of the head assembly 20 in the horizontal direction by rotating the position adjuster 34.

(8) The pressure damper 22 that adjusts the pressure of the ink and then supplies the ink to the head assembly 20 is disposed on top of the head assembly 20 of this embodiment, and then ink supply connector 32 is coupled to a plurality of ink inflow units 96 of the pressure damper 22 to be simultaneously detachable. According to this embodiment, the ink supply connector 32 can be easily attached to the pressure damper 22.

### REFERENCE SIGNS LIST

1 Inkjet printer (printing device)
5 Ink ejection mechanism
6 Inkjet head
7 Carriage
22 Pressure damper (pressure adjuster)
30 Fixing unit
32 Ink supply connector
34 Position adjuster
40 First fixing component
42 Second fixing component
50 Operation member
52 Head fixing member
64 Lever member
66 Pressing member
74 Rotary member
96 Ink inflow unit

1. An ink ejection mechanism, comprising:
a carriage, configured to move along a print surface of a medium;
an inkjet head, configured to be detachably disposed on the carriage and eject ink onto the medium; and
a fixing unit, configured to fix the inkjet head to the carriage by pressing the inkjet head from above.

2. The ink ejection mechanism as set forth in claim 1, wherein the fixing unit includes:
a first fixing component, configured to fix the fixing unit to the carriage; and
a second fixing component, configured to fix the inkjet head to the carriage.

3. The ink ejection mechanism as set forth in claim 2, wherein
the first fixing component is a male screw which is inserted into a hole formed in the fixing unit, and
the male screw is screwed into a female screw formed in the carriage.

4. The ink ejection mechanism as set forth in claim 2, wherein the second fixing component includes:
an operation member, provided outside a side surface portion of the fixing unit, and
a head fixing member that is provided inside the fixing unit and is configured to hold down the inkjet head from above depending on an operation on the operation member to fix the inkjet head to the carriage.

5. The ink ejection mechanism as set forth in claim 4, wherein the head fixing member includes:
a lever member that is pivoted depending on the operation on the operation member, and
a pressing member that is attached to a lower end of the lever member via a biasing member and is configured to press the inkjet head against the carriage.

6. The ink ejection mechanism as set forth in claim 1, wherein
the carriage includes a position adjuster configured to adjust a position of the inkjet head in a horizontal direction on an upper surface of the carriage.

7. The ink ejection mechanism as set forth in claim 6, wherein
the position adjuster includes a cylindrical rotary member configured to rotate around a central shaft, and
the cylindrical rotary member has a contact surface which comes into contact with a side surface of the inkjet head directly or via another member, the contact surface having a thickness which changes in a rotation direction.

8. The ink ejection mechanism as set forth in claim 1, wherein
a pressure adjuster configured to adjust pressure of the ink and supply the ink to the inkjet head is disposed on top of the inkjet head, and
an ink supply connector is coupled to a plurality of ink inflow units of the pressure adjuster to be simultaneously detachable together.

9. A printing device, comprising:
the ink ejection mechanism as set forth in claim 1.

10. A method for fixing an inkjet head that is detachably disposed on a carriage which moves along a print surface of a medium and that ejects ink onto the medium, the method comprising:
a first step of disposing the inkjet head on the carriage;
a second step of disposing, on the carriage from above the inkjet head, a fixing unit that fixes the inkjet head to the carriage;
a third step of fixing the fixing unit to the carriage by a first fixing component provided in the fixing unit;
a fourth step of adjusting a horizontal position of the inkjet head on an upper surface of the carriage by a position adjuster provided on the upper surface of the carriage; and
a fifth step of fixing the inkjet head to the carriage by a second fixing component provided in the fixing unit.

11. A printing device, comprising:
the ink ejection mechanism as set forth in claim 2.

12. A printing device, comprising:
the ink ejection mechanism as set forth in claim 3.

13. A printing device, comprising:
the ink ejection mechanism as set forth in claim 4.

14. A printing device, comprising:
the ink ejection mechanism as set forth in claim 5.

15. A printing device, comprising:
the ink ejection mechanism as set forth in claim 6.

16. A printing device, comprising:
the ink ejection mechanism as set forth in claim 7.

17. A printing device, comprising:
the ink ejection mechanism as set forth in claim 8.
